(19) United States
(12) Patent Application Publication
(10) Pub. No.: US 2025/0068376 A1
(43) Pub. Date: Feb. 27, 2025

(54) SYSTEM AND METHOD FOR INTERACTIVE MEETING WITH BOTH IN-ROOM ATTENDEES AND REMOTE ATTENDEES

(71) Applicant: LADUMA, INC., Salt Lake City, UT (US)

(72) Inventors: John HAGERTY, Liverpool (GB); Martin PRENDERGAST, Liverpool (GB)

(21) Appl. No.: 18/689,021

(22) PCT Filed: Sep. 6, 2022
(86) PCT No.: PCT/IB2022/058374

§ 371 Date: Mar. 4, 2024

(30) Foreign Application Priority Data
Sep. 6, 2021 (GB) 2112675.0

(51) Int. Cl. G06F 3/14; H04L 12/18

(52) U.S. Cl. CPC G06F 3/1454; G06F 3/1423; H04L 12/1822; H04L 12/1831

(57) ABSTRACT

A system for enabling an interactive meeting between attendees physically located in a room as well as attendees located remotely from the room, comprising: a server which runs an application for controlling the interactive meeting; a plurality of projectors located in the room; and a plurality of displays in the room for displaying content from the plurality of projectors; wherein the application is arranged so that user provided settings can be configured to select which, of a plurality of types of content, is to be displayed on which of the plurality of displays; and wherein an attendee located remotely from the room, joins an interactive meeting via a web application using a web browser, and uses the web browser to view content being displayed on the displays in the room by using the web application on a first device to access content of one of the plurality of types, and using the web application on a second device to access content of another one of the plurality of types; and wherein the web application is arranged so that user provided settings can be configured to select which of a plurality of types of content is to be displayed on which of the first or second device.

### FIELD OF THE INVENTION

The present invention relates to a system and method for enabling an interactive meeting having both attendees who are in the physical meeting room, as well as attendees who are located remotely from the physical meeting room.

### BACKGROUND OF THE INVENTION

Existing systems for enabling interactive meetings, such as Microsoft Teams, Google Hangouts, and Zoom, allow for meetings to take place with remotely located meeting attendees, as well as any attendees who are together in the same physical room. However, the experience is not fully interactive, especially for the remote attendees, as there is usually one person in control of any content which is displayed to all the other attendees, and such content is usually limited to one document presently being shared and discussed, as well as video feeds from each of the remote attendees.

It would be very useful to have a more immersive meeting experience, for all attendees, in-room and remote, to help encourage better cooperation and free flow of ideas and input from each of the attendees. The technical means for achieving this has not yet been available.

### SUMMARY OF THE INVENTION

The present invention provides a system for enabling an interactive meeting between attendees physically located in a room as well as attendees located remotely from the room, comprising: a server which runs an application for controlling the interactive meeting; a plurality of projectors located in the room; and a plurality of displays in the room for displaying content from the plurality of projectors; wherein the application is arranged so that user provided settings can be configured to select which, of a plurality of types of content, is to be displayed on which of the plurality of displays; and wherein an attendee located remotely from the room, joins an interactive meeting via a web application using a web browser, and uses the web browser to view content being displayed on the displays in the room by using the web application on a first device to access content of one of the plurality of types, and using the web application on a second device to access content of another one of the plurality of types; and
wherein the web application is arranged so that user provided settings can be configured to select which of a plurality of types of content is to be displayed on which of the first or second device.

The invention also provides a method of enabling an interactive meeting between attendees located physically in a room as well as attendees located remotely from the room, comprising the steps of: controlling a first display, located in the room, to display a first type of content; controlling a second display, located in the room, to display a second type of content; and controlling a third display, located in the room, to display a third type of content; wherein a user configures an application to select, for each of the first, second and third displays, which type of content is to be displayed on which display; wherein an attendee located remotely from the room, joins an interactive meeting via a web application using a web browser and uses the web browser to view content being displayed on the displays in the room and uses the web application on a first device to access content of one of the plurality of types, and uses the web application on a second device to access content of another one of the plurality of types; wherein the web application is arranged so that user provided settings can be configured to select which of a plurality of types of content is to be displayed on which of the first or second device.

The invention also provides a computer program corresponding to the above method.

By the use of the invention as described above, an attendee who is located in the room can experience content of a different type being displayed on a different display, and the settings of content/display can be set for subsequent meetings without having to reconfigure the settings. Likewise, the attendee who is located remote from the room can simulate the rich diverse experience of the in-room attendee by viewing content of one type on one device and viewing content of another type on another device, all without having to reconfigure the settings of preferred technical choices from one meeting session to another.

In this way, a remote attendee can experience the meeting much better than in previous systems, and much more similar to the in-room attendees' experience. This greatly increases user participation and engagement in meetings, even when an attendee cannot attend the meeting in person.

### BRIEF DESCRIPTION OF THE DRAWINGS

FIG. 1 is a block diagram of the overall topology of the new platform, according to a preferred embodiment of the present invention;

FIG. 2 is a block diagram of a plurality of displays showing various types of content, according to a preferred embodiment of the present invention; and

FIG. 3 is a flowchart, showing the steps of a method according to a preferred embodiment of the present invention.

### DETAILED DESCRIPTION OF THE PREFERRED EMBODIMENTS

According to a preferred embodiment of the present invention, a new software platform has been developed, which sits on top of an existing meeting collaboration package, such as Microsoft Teams. The new software platform integrates together various types of content, and allows each of the attendees in the meeting, whether they are in-room or remote, to view the various types of content, and to share new content of the various types with the other attendees (whether they are in-room or remote).

If the users are in-room, projectors (located in the physical room) can be used to display the various types of content onto multiple walls (or generally, displays) of the physical room.

These projectors which display content on walls can provide interactive (touch screen) displays, as well as normal displays.

Examples of the types of content which can be interactively viewed and shared via the new software platform are the following:
an interactive whiteboard, which allows attendees of a meeting to draw or write on a virtual surface, and the virtual surface is displayed to the attendees. Such interactive whiteboards, by themselves, are existing and well known;
video and/or audio streams from each of the attendees, whether they are in-room or remote, so this would be outputs from cameras/microphones located on the attendees' laptops/tablets/phones; and
documents from each of the attendees, so this would be, for example, word processing documents (such as Microsoft Word documents), Powerpoint documents, spreadsheets, pdf documents, still images, or the like.

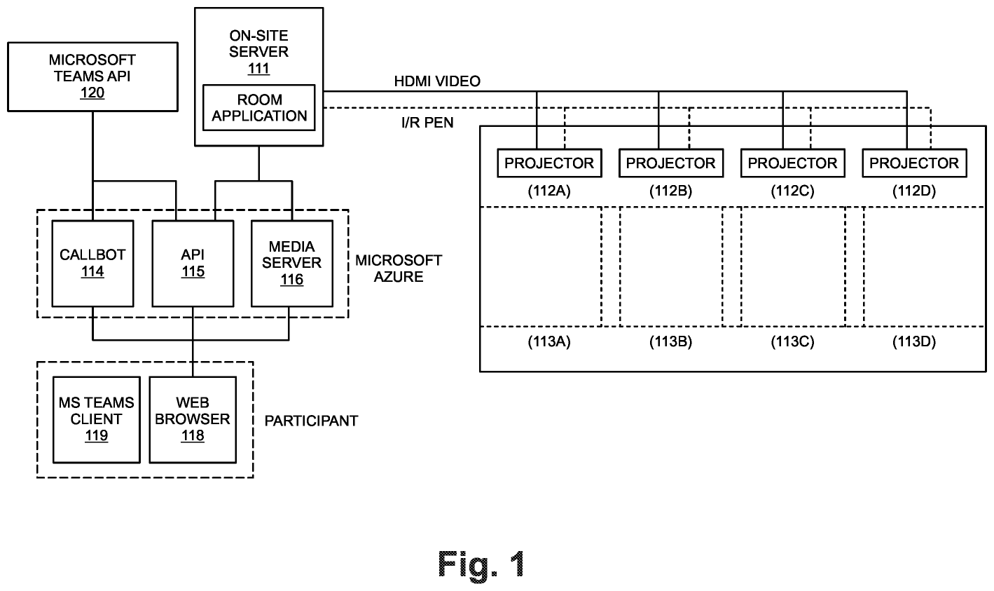

FIG. 1 is a block diagram showing the overall topology of the new platform. An on-site server 111 is provided for running the standalone (“standalone” because it does not require a web browser to run, and instead runs directly on an operating system, such as Microsoft Windows) application (also known as the room application). The room application, as described above, controls the projectors 112a-112d to display selected content onto walls (or, generally, displays) 113a-113d. As shown, HDMI signals are sent from the server 111 to the projectors 112a-112d, and infrared pen data is communicated between these units as well.

As also shown in FIG. 1, various new software components have been developed which are running on an external cloud, using an external cloud service provider, such as Microsoft Azure. These components are:
a Callbot 114, which controls and tracks the joining and leaving of attendees to a meeting, and also processes incoming video which is packaged and sent to the media server 116 (to be described below);
a new API 115 which provides a suite of functions consumed by a web application (which will be described below), allowing users to login, view calendars, book meetings and attend meetings; and
a media server 116 which handles live connections and directs incoming and outgoing media sources to peer connections, allowing documents to be shared, participants to join and leave meetings, handling the receiving and transmitting whiteboard changes and processing video feed data.

The participants (or attendees) of a meeting use the new platform by accessing it via a web browser 118 using a web browser application as will be described below. The participant also uses the Microsoft Teams Client 119 in the preferred embodiment, as the new platform is running on top of a collaborative meeting tool such as Teams. Likewise, a Microsoft Teams API 120 is used to ensure seamless integration between the new platform and Teams.

Attendees can join an interactive meeting by using a web application, via a standard web browser, to access the meeting, allowing access to the interactive white board, allowing the attendee to stream its video and audio to the meeting (a video stream showing the face of the attendee and an audio stream having the words being spoken by the attendee), and allowing the attendee to share documents with the overall meeting. The web application also enables the attendee to receive such various types of content which are originating from the other attendees in the meeting.

The web application allows the attendee to open one browser window or tab, and then use an in-application pull-out menu to switch between different types of content (interactive whiteboard, video/audio, or documents). An attendee can also open other browser windows or tabs and have one browser window/tab dedicated to each type of content. A second device, such as a tablet, can also be used to open an additional instance of the web application, to enable the attendee to view one type of content on one device (laptop) and another type of content on another device (tablet).

A remote attendee could simulate the in-room multi-screen experience by, for example, opening three instances of the web application, one on the laptop, one on the tablet and a third on a smartphone, and assigning a different type of content to each of the devices. This would enable, for example, the whiteboard to be viewed and edited on the tablet (which has a capability to use a pencil on the screen), a Word document to be viewed and edited on the laptop (which has a QWERTY keyboard allowing easy text editing), and a smartphone to be used to display a video content of an attendee who is presently speaking.

Attendees can also join a meeting by using the standalone application mentioned above, which does not require a browser to run, but instead runs on an operating system directly (such as on Microsoft Windows). This standalone application controls the content types being displayed in a physical room, including controlling multiple projectors to display content of various types on a plurality of large video screen displays in the room.

The standalone application also receives inputs from the projectors/displays when the meeting attendees interact with the content being displayed, so that the interactions can be shared with each of the other attendees, whether they be in-room or remote. Typically, for a projector-driven system, the user interactions would be conveyed from an infrared pen supplied by the projector manufacturer which, in turn, relates these details back via the projector to the server running the standalone application. It would also be possible to process touch screen movements back to the server in a similar manner, if the projector/video screen accepted these inputs.

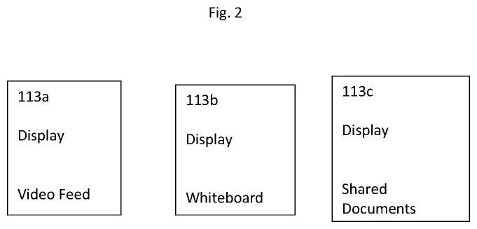

The standalone application is capable of being set to remember which display should be used for each specific type of content, as well as how many pieces of content of each type should be displayed on a particular display (this is called tiling). For example, as shown in FIG. 2, one possible set up at one location could have three projectors set to display a video feed on one display (display 113a), the whiteboard on another (display 113b), and shared documents on the final display screen (display 113c).

Specifically, the standalone application makes use of user-provided settings to decide how to handle the displaying of content within the system. The settings are configured on installation, but can be changed within the standalone application. These settings/configurations cover:
how many displays there are connected to the system and their display order, left to right;
what content the displays are set to display (video/whiteboard/shared documents);
the maximum number of tiles the display can show;
whether the display is an interactive/touch sensitive display;
whether the display is a primary display for Windows;
where the display is a projector which is networked, the settings also store: the IP address of the projector, the username and password, and the port number (where different from the default port).

Alternatively, another set up may use two large touch screen TVs and have one set to display the video screen and the second to display up to four tiles of whiteboard or shared documents.

The settings of the standalone application are configured via the software and can be changed by the user, with the changes persisting for the next use of the application. The user may also edit these settings during a meeting by using an in-meeting settings menu of the standalone application.

Also, the settings of the web application can be similarly configured via the software and can be changed by the user, so that the remote user, who chooses to view content of one type on one device (e.g., a laptop) and who chooses to view content of another type on another device (e.g, a mobile phone) can always view such content on such device, from one meeting session to another (the settings would persist).

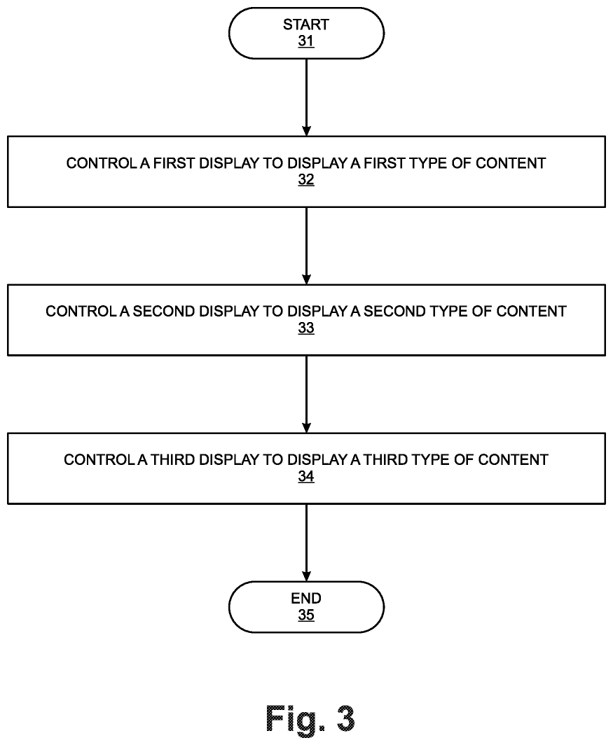

FIG. 3 is a flowchart showing the steps taken, under control of the room application, according to a preferred embodiment of the present invention.

At step 31, the process begins.

At step 32, the room application controls the system of FIG. 1 to display content of a first type, such as a video stream, on a first display.

At step 33, the room application controls the system of FIG. 1 to display content of a second type, such as an interactive whiteboard, on a second display.

At step 34, the room application controls the system of FIG. 1 to display content of a third type, such as a document (for example, a Microsoft Word document), on a third display.

At step 35, the process ends.

An example will now be provided of an instance of a typical meeting, explaining how the new software platform produces technical advantages over existing collaborative meeting systems.

A meeting is scheduled between three people, Ahmed, Billie and Charlie.

Ahmed and Billie are sat together in a meeting room which is set up as an interactive room as described above. The room contains a Windows machine running the standalone application and it has three projector displays.

Charlie will be joining the meeting from home on his laptop.

When the meeting starts, Ahmed and Billie enter the meeting code into the standalone application, and it joins the meeting. They additionally join the meeting on a laptop to allow their video and audio to be put into MS Teams and distributed through the new platform.

When there is a video coming into the platform via MS Teams, the standalone application detects it and starts to show the video feed on the display dedicated to video.

Charlie joins the meeting in MS Teams on his laptop and also signs into the web application and joins the meeting.

When Charlie speaks, MS Teams' ‘active speaker’ video mode displays his video feed in the platform. In the room, the projector dedicated to video content displays Charlie on the wall when he is speaking, giving him a greater presence in the meeting for those in the room that are not looking at their laptop.

When Charlie shares a PowerPoint presentation he has produced about an upcoming project in the platform, the shared document appears on the display in the room that has been dedicated to shared content.

Billie wants to draw a project timeline on the whiteboard and opens a new whiteboard via her laptop. This is then displayed on the display in the room that is dedicated to the whiteboard. Charlie switches using the menu in the web application to view the whiteboard and contributes to the project timeline.

A discussion ensues, and in order to be able to watch the incoming video feed from the meeting room and see the whiteboard, Charlie uses his iPad to sign into the platform. He is now watching the video feed on his iPad while drawing on the whiteboard on his laptop.

Ahmed wants to take notes about the project timeline and opens a shared Word document via his laptop. This is tiled on the display dedicated to the shared content, meaning that half the display is given to the already open PowerPoint presentation and the other half now shows the Word document.

1. A system for enabling an interactive meeting between attendees physically located in a room as well as attendees located remotely from the room, comprising:
a server which runs an application for controlling the interactive meeting;
a plurality of projectors located in the room; and
a plurality of displays in the room for displaying content from the plurality of projectors;
wherein the application is arranged so that user provided settings can be configured to select which, of a plurality of types of content, is to be displayed on which of the plurality of displays; and
wherein an attendee located remotely from the room, joins an interactive meeting via a web application using a web browser, and uses the web browser to view content being displayed on the displays in the room by using the web application on a first device to access content of one of the plurality of types, and using the web application on a second device to access content of another one of the plurality of types; and
wherein the web application is arranged so that user provided settings can be configured to select which of a plurality of types of content is to be displayed on which of the first or second device.

2. The system of claim 1 wherein the plurality of types of content includes a video feed from an attendee, an interactive whiteboard, or a document.

3. The system of claim 2, wherein the document is provided by an attendee located remotely from the room.

4. The system of claim 1, wherein an attendee located remotely from the room uses the web application to open additional instances of a web browser session on a device running the web browser and web application, in order to view content of the plurality of types.

5. The system of claim 1, wherein the first device is a laptop computer and the second device is a tablet computer or mobile phone.

6. The system of claim 1, wherein the user-provided settings, once configured, persist from one meeting to another.

7. A method of enabling an interactive meeting between attendees located physically in a room as well as attendees located remotely from the room, comprising the steps of:
(a) controlling a first display, located in the room, to display a first type of content;
(b) controlling a second display, located in the room, to display a second type of content; and
(c) controlling a third display, located in the room, to display a third type of content;
wherein a user configures an application to select, for each of the first, second and third displays, which type of content is to be displayed on which display;
wherein an attendee located remotely from the room, joins an interactive meeting via a web application using a web browser and uses the web browser to view content being displayed on the displays in the room and uses the web application on a first device to access content of one of the plurality of types, and uses the web application on a second device to access content of another one of the plurality of types;
wherein the web application is arranged so that user provided settings can be configured to select which of a plurality of types of content is to be displayed on which of the first or second device.

8. The method of claim 7 wherein the first, second and third types of content are a video feed from an attendee, an interactive whiteboard, and a document.

9. The method of claim 8, wherein the document is provided by an attendee located remotely from the room.

10. The method of claim 7, wherein an attendee located remotely from the room uses the web application to open additional instances of a web browser session on a device running the web browser and web application, in order to view content of the plurality of types.

11. The method of claim 7, wherein the first device is a laptop computer and the second device is a tablet computer or mobile phone.

12. The method of claim 7, wherein once the user configures the application to create a set of configurations, the set of configurations persist from one meeting to another.

13. A computer program for carrying out the steps of any preceding method claim when the computer program is executed on a computer processing system.
